(19) United States
(12) Patent Application Publication
(10) Pub. No.: US 2007/0124515 A1
(43) Pub. Date: May 31, 2007

(54) Coordinator input apparatus

(75) Inventors: Minoru Ishikawa, Kanagawa-ken (JP); Noriyuki Shikina, Kanagawa-ken (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, TOKYO (JP)

(21) Appl. No.: 10/557,520

(22) PCT Filed: Jun. 8, 2005
(86) PCT No.: PCT/JP05/10900

§ 371 Date: Jan. 30, 2007

(30) Foreign Application Priority Data
Jun. 8, 2004 (JP) 2004-169977

(51) Int. Cl. G06F 3/00

(52) U.S. Cl. 710/15

(57) ABSTRACT

A coordinate input apparatus is constituted by a plurality of X interconnecting lines and a plurality of Y interconnecting lines disposed to intersect with each other in a matrix fashion; a closed-loop forming circuit for being electrically connected with the X interconnecting lines or the Y interconnecting lines so as to switchably connect a predetermined number of the X interconnecting lines or a predetermined number of the Y interconnecting lines to form a closed loop; and a detection circuit for detecting a signal outputted from the closed loop in response to a position indicator for indicating a position in a coordinate input area where the X interconnecting lines and the Y interconnecting lines are disposed in the matrix fashion. In the coordinate input apparatus, the closed loop is a multiple closed loop.

### TECHNICAL FIELD

The present invention relates to a coordinate input apparatus which is used when a character or a graphic image is inputted in a personal computer, a word processor, or the like and is capable of functioning as a position detection sensor.

### BACKGROUND ART

As a conventional position detection sensor, there has been known such a sensor that a position coordinate is detected by utilizing electromagnetic wave. As an example of such a conventional position detection sensor, Japanese Laid-Open Patent Application (JP-A) No. Hei 10-49301 has disclosed a position detection sensor utilizing X and Y display drive lines as a sensor as shown in FIG. 5. Referring to FIG. 5, a coordinate input apparatus 1 includes an active matrix-type liquid crystal panel having a plurality of X drive lines and a plurality of Y drive lines which intersect with the X drive lines, the X drive lines being disposed with a predetermined spacing therebetween and the Y drive lines being disposed with a predetermined spacing therebetween; switches for display; and switching devices for forming a closed loop. This apparatus is an apparatus for performing position detection by utilizing electromagnetic wave from a position indicator 2.

The position indicator 2 indicates a position on the liquid crystal panel by an end portion from which electromagnetic wave is emitted so as to generate an induction current in a closed-loop circuit.

The coordinate input apparatus 1 detects a coordinate of the position on the liquid crystal panel indicated by the position indicator 2 on the basis of a waveform of an electromotive force induced in a closed-loop circuit for the X drive lines or the Y drive lines by the electromagnetic wave emitted from the position indicator 2.

In the apparatus 1, a closed-loop circuit forming means for the X drive lines includes a plurality of switching devices, disposed on a substrate constituting the liquid crystal panel, connected between terminals of predetermined X drive lines. Further, a closed-loop circuit forming means for the Y drive lines includes a plurality of switching devices, disposed on a substrate constituting the liquid crystal panel, connected between terminals of predetermined Y drive lines.

The apparatus 1 has input/output terminals and a first drive circuit (X drive/X current detection circuit) for outputting sequentially drive signals to the respective X drive lines in a display period and, in a position detection period subsequent to the display period, for successively forming a closed-loop circuit of X drive lines including two X drive lines, located with a predetermined spacing therebetween, of the plurality of the X drive lines at a predetermined portion along an X drive line arrangement direction from one end of the liquid crystal panel to the other end of the liquid crystal panel. Further, the apparatus 1 has input/output terminals and a first drive circuit (Y drive/Y current detection circuit) for outputting sequentially drive signals to the respective Y drive lines in a display period and, in a position detection period subsequent to the display period, for successively forming a closed-loop circuit of Y drive lines including two Y drive lines, located with a predetermined spacing therebetween, of the plurality of the Y drive lines at a predetermined portion along an Y drive line arrangement direction from one end of the liquid crystal panel to the other end of the liquid crystal panel.

As described above, the coordinate input apparatus (position detection apparatus) 1 detects a coordinate of the position on the liquid crystal panel indicated by the position indicator 2 in the position detection period on the basis of a waveform of an electromotive force induced in closed-loop circuits for successively scanned X drive lines and Y drive lines by the electromagnetic wave emitted from the position indicator 2.

However, in the conventional position detection apparatus, it cannot be said that the closed-loop circuits for the X drive lines and the Y drive lines provide, e.g., a sufficient receiving sensitivity of electromagnetic wave generated from the position indicator. Accordingly, there is still room for improvement.

### DISCLOSURE OF THE INVENTION

A principal object of the present invention is to provide a coordinate input apparatus having solved the above described problem of the conventional position detection apparatus.

A specific object of the present invention is to provide a coordinate input apparatus having a good sensitivity.

According to an aspect of the present invention, there is provided a coordinate input apparatus, comprising:

a plurality of X interconnecting lines and a plurality of Y interconnecting lines disposed to intersect with each other in a matrix fashion;

a closed-loop forming circuit for being electrically connected with the X interconnecting lines or the Y interconnecting lines so as to switchably connect a predetermined number of the X interconnecting lines or a predetermined number of the Y interconnecting lines to form a closed loop; and

a detection circuit for detecting a signal outputted from the closed loop in response to a position indicator for indicating a position in a coordinate input area where the X interconnecting lines and the Y interconnecting lines are disposed in the matrix fashion;

wherein the closed loop is a multiple closed loop.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a circuit diagram for illustrating a constitution of a coordinate input apparatus of electromagnetic induction-type using a liquid crystal panel, according to an embodiment of the present invention.

FIG. 2 is a view showing a double closed-loop circuit in the embodiment of the present invention.

FIG. 3 is a circuit diagram for illustrating a constitution of a coordinate input apparatus of electromagnetic induction-type using a liquid crystal panel, according to another embodiment of the present invention.

FIG. 4 is a sectional view showing a pixel structure of an electrophoretic display panel used in the present invention.

FIG. 5 is a view for illustrating a conventional coordinate input apparatus (position detection apparatus).

### BEST MODE FOR CARRYING TO THE INVENTION

Hereinbelow, embodiments of the present invention will be described with reference to the drawings.

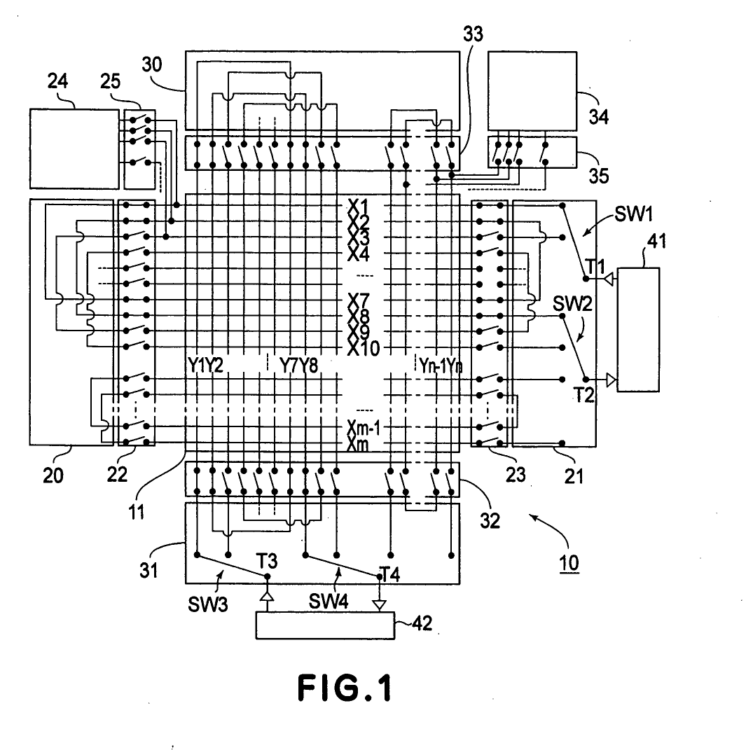

FIG. 1 shows a circuit diagram of an embodiment of the coordinate input apparatus according to the present invention.

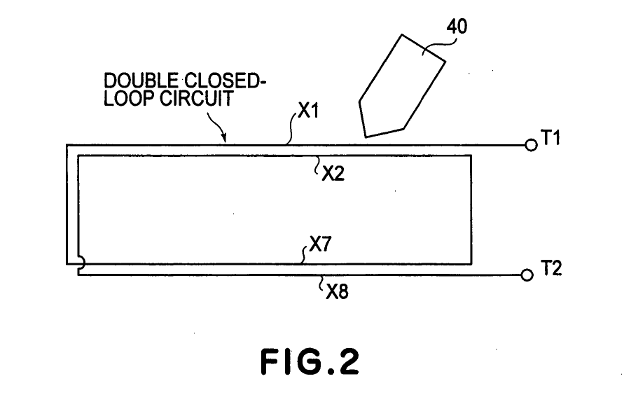

Referring to FIG. 1, a coordinate input apparatus 10 in this embodiment includes: a plurality of X interconnecting lines (X drive lines) X1, X2, . . . , Xm−1, Xm and a plurality of Y interconnecting lines (Y drive lines) Y1, Y2, . . . , Yn−1, Yn are disposed to intersect with each other in a matrix fashion; closed-loop forming circuits 20 to 23 and 30 to 33 which are electrically connected with the X interconnecting lines or the Y interconnecting lines so as to switchably connect a predetermined number of the X interconnecting line, or a predetermined number of the Y interconnecting lines to form closed loops (e.g., a closed loop as shown in FIG. 2); and a detection circuit for detecting a signal outputted from the closed loop in response to a position indicator for indicating a position in a coordinate input area (display panel 11) where the X interconnecting lines and the Y interconnecting lines are disposed in the matrix fashion. The coordinate input apparatus is characterized in that the closed loop is a multiple closed loop (e.g., a double closed loop as shown in FIG. 2).

The closed loop for the X interconnecting lines (row interconnecting lines in this embodiment) includes switch circuits 21, 22 and 23 for selecting first to four X interconnecting lines (X2, X7, X8 and X1) from the plurality of X interconnecting lines so that:

a first terminal of the first X interconnecting line (X2) is connected with a first terminal of the second X interconnecting line (X7),

a first terminal of the third X interconnecting line (X8) is connected with a first output terminal (T2),

a second terminal of the third X interconnecting line (X8) is connected with a second terminal of the first X interconnecting line (X2),

a first terminal of the fourth X interconnecting line (X1) is connected with a second output terminal (T1), and

a second terminal of the fourth X interconnecting line (X1) is connected with a second terminal of the second X interconnecting line (X7).

Similarly, the closed loop for the Y interconnecting lines (column interconnecting lines in this embodiment) includes switch circuits 31, 32 and 33 for selecting first to four Y interconnecting lines (Y2, Y7, Y8 and Y1) from the plurality of Y interconnecting lines so that:

a first terminal of the first Y interconnecting line (Y2) is connected with a first terminal of the second Y interconnecting line (Y7),

a first terminal of the third Y interconnecting line (Y8) is connected with a first output terminal (T4),

a second terminal of the third Y interconnecting line (Y8) is connected with a second terminal of the first Y interconnecting line (Y2),

a first terminal of the fourth Y interconnecting line (Y1) is connected with a second output terminal (T3), and

a second terminal of the fourth Y interconnecting line (Y1) is connected with a second terminal of the second Y interconnecting line (Y7).

The switching circuit is actuated so as to sequentially from the closed loops on the matrix of the X and Y interconnecting lines at a constant pitch with a lapse of time. In FIG. 1, only a part of interconnecting relationships is indicated so as facilitate understanding of the constitution of this embodiment.

In the embodiment shown in FIG. 1, on the matrix of the X and Y interconnecting lines, a closed loop (e.g., a closed loop formed with four X interconnecting lines Xl, X2, X7 and X8) formed timewise previously and a subsequent closed loop (e.g., a closed loop formed with other four interconnecting lines X3, X4, X8, and X9) formed after the closed loop are selected to have an embedded structure.

As described above, in the typical embodiment of the present invention, the means for forming the multiple closed loop (not less than a double closed loop) including the plurality of X interconnecting lines (X drive lines) is provided with a display drive circuit (driver) and the closed-loop forming circuit at one terminal portion and with, at the other terminal portion, a switching circuit which connects the drive lines with the display drive circuit and the closed-loop forming circuit and have switches for forming the closed loops and outputting an induction current by electromagnetic wave from the position indicator while sequentially switching the respective closed loops. By turning the switching circuit on, a plurality of multiple closed-loop circuits are formed with the drive lines.

The display drive circuit and the closed-loop forming circuit may be a single driver or circuit which has the functions of display drive circuit and closed-loop forming circuit in combination.

The switching circuit for connecting the drive lines with the display drive circuit and the closed-loop forming circuit may be a display drive circuit having such a connecting function.

The X display drive circuit is disconnected from the X drive lines by some means during a coordinate detection period (position detection period) so as to induce the electromotive force in the closed-loop circuit.

In the operation, the switching circuit is placed in an OFF state during a display period, so that a drive signal is supplied from the display driver, connected with the X drive lines at one terminal, to the X drive lines. On the other hand, during a detection period for detecting a position by the position indicator, the switching circuit is placed in an ON state, so that the plurality of multiple closed-loop circuits using the drive lines are formed and a current induced by the electromagnetic wave from the position indicator is outputted. In such a manner, the induction current from the plurality of multiple closed-loop circuits formed in the arrangement direction of the X drive lines in successively outputted and an X coordinate of the position indicator is detected from a maximum of the induction current values of the respective closed-loop circuits.

On the other hand, the means for forming the multiple closed loop (not less than a double closed loop) including the plurality of Y interconnecting lines (Y drive lines) is also provided with a display drive circuit (driver) and the closed-loop forming circuit at one terminal portion and with, at the other terminal portion, a switching circuit which connects the drive lines with the display drive circuit and the closed-loop forming circuit and have switches for forming the closed loops and outputting an induction current by electromagnetic wave from the position indicator while sequentially switching the respective closed loops. By turning the switching circuit on, a plurality of multiple closed-loop circuits are formed with the drive lines.

Also in this case, the display drive circuit and the closed-loop forming circuit may be a single driver or circuit which has the functions of display drive circuit and closed-loop forming circuit in combination. Further, the switching circuit for connecting the drive lines with the display drive circuit and the closed-loop forming circuit may be a display drive circuit having such a connecting function.

The Y display drive circuit is disconnected from the Y drive lines by some means during a coordinate detection period (position detection period) so as to induce the electromotive force in the closed-loop circuit.

Also in the operation with respect to the Y drive lines, the switching circuit is placed in an OFF state during a display period, so that a drive signal is supplied from the display driver, connected with the Y drive lines at one terminal, to the Y drive lines. On the other hand, during a detection period for detecting a position by the position indicator, the switching circuit is placed in an ON state, so that the plurality of multiple closed-loop circuits using the drive lines are formed and a current induced by the electromagnetic wave from the position indicator is outputted. In such a manner, the induction current from the plurality of multiple closed-loop circuits formed in the arrangement direction of the Y drive lines in successively outputted and an Y coordinate of the position indicator is detected from a maximum of the induction current values of the respective closed-loop circuits.

### EMBODIMENT 1

In FIG. 1, an electromagnetic induction-type coordinate input apparatus 10 includes an active matrix-type liquid crystal display panel 11 which includes X drive lines and Y drive lines disposed in a matrix fashion for not only the liquid crystal display panel but also the coordinate input apparatus.

The liquid crystal display panel 11, similarly as in a conventional one includes a plurality of X-drive lines Xl to Xm and a plurality of Y-drive lines Y1 to Yn which are disposed to intersect with each other in a matrix fashion. At each of intersections of these X and Y drive lines, an active device or element (not shown), such as a transistor or a diode and a liquid crystal pixel (not shown) are disposed.

In the following description, the liquid crystal display panel will be explained as an example but, other than the liquid crystal display panel (apparatus), the present invention may preferably be applicable to any displays, such as EL (electroluminescent) display, plasma display, electron emission-type display, and the like so long as they includes drive lines in an X direction and a Y direction are disposed to intersect with each other to constitute a matrix display portion.

At one terminal portion of the X drive lines, in addition to an X drive circuit 24 and a switching circuit 25 for electrically connecting the X drive circuit 24 with the X drive lines, a circuit 20 having m terminals corresponding to the m X-drive lines which are electrically connected in a manner described later (hereinafter, this circuit is referred to as a “first closed-loop forming circuit”) and a first switching circuit 22 for effecting open/close operation between the closed-loop forming circuit 20 and the X-drive lines. Of these circuits, at least the first closed-loop forming circuit 20 and the switching circuit 22 and formed on the active matrix substrate constituting the liquid crystal panel 11. The X drive circuit may be formed on another substrate but may be an IC chip mounted (hybrid-integrated) on or a monolithic-integrated TFT circuit disposed on the substrate together with the liquid crystal panel.

At the other terminal portion of the X-drive lines, a circuit 21 having m terminals corresponding to the m X-drive lines, which are electrically connected in correspondence with the first closed-loop forming circuit 22 in a manner described later, and guiding an end of loop to the outside via a switch (hereinafter, this circuit is referred to as a “second closed-loop forming circuit”) and a second switching circuit 23 for effecting open/close operation between the closed-loop forming circuit 21 and the X-drive lines are disposed on the same substrate together with the liquid crystal panel.

These first and second closed-loop forming circuits 20 and 21 and the switching circuits 22 and 23 form the closed loops. The closed loop referred to in the present invention constitutes, as shown in FIG. 2, a closed circuit having a loop formed in the coordinate input area of the matrix of the X and Y drive lines and being connected at two terminals T1 and T2 with an external detection circuit 41 including an AC power source and a current detection circuit described later. Similarly, with respect to the Y-drive lines, a Y drive circuit 34, a switching circuit 35, a first closed-loop forming circuit 30, and a first switching circuit 33 are disposed at one terminal portion, and at the other terminal portion, a second closed-loop forming circuit 31 and a second switching circuit 32 are disposed. Further, a double closed loop is formed by the circuits 30, 31, 32 and 33 and four Y-drive lines Y1, Y2, Y7 and Y8 and is connected with a detection circuit 42 via terminals T3 and T4.

Hereinbelow, these circuits disposed with respect to the X-drive lines will be described but the same goes for the Y-drive lines.

Each of the first and second closed-loop forming circuits 20 and 21 includes the m terminals corresponding to the m X-drive lines X1 to Xm and internal interconnecting lines connecting the m terminals. When the double closed loop is constituted, the internal interconnecting lines of the first closed-loop forming circuit 20 connect the X-drive lines X1 and X7 and connect the X-drive lines X2 and X8. In correspondence therewith, the internal interconnecting lines of the second closed-loop forming circuit 21 connect the X-drive lines X7 and X2 and connect the X-drive lines X1 and X8 with the terminals T1 and T2 via switches SW1 and SW2, respectively, as shown in FIG. 1. As a result, the double (multiple) closed loop is formed by the four X-drive lines X1, X2, X7 and X8. The connection in the second closed-loop forming circuit is not necessarily performed in such a manner that the inner two X-drive lines are connected and the outer two X-drive lines are used as lead terminals as described above and may be arbitrarily set. Other four X-drive lines selected from the m X-drive lines are similarly connected and the still other four X-drive lines are connected. This connecting operation is repeated to effect connection of all the X-drive lines.

The above described connection may be constituted so that the closed loops are distributed, preferably uniformly, over the entire X-drive lines. For example, four X-drive lines X1, Xi+1, Xi+6, and Xi+7 are selected to form a closed loop while interposing other four X-drive lines Xi+2 to Xi+5 of which the latter two X-drive lines Xi+4 and Xi+5 are selected together with other two X-drive lines Xi+10 and Xi+11 to form a subsequent closed loop, thus constituting a closed loop array having an embedded structure every four drive lines.

Generally, when the closed loop array is formed with a uniform spacing, it can be easily estimated that one closed loop size b (defined as the number of interposed drive lines) is selected from integers other than three integers (ka-3, ka-2 and ka-1; k=integer) immediately before integral multiple of a (ka) when a represents a pitch of the closed loop array. In a similar manner, it is possible to form a triple closed loop or a multiple closed loop not less than the triple closed loop.

The closed-loop forming circuits 20 and 21 and the switching circuits 22 and 23 for effecting the open/close operation between the X-drive lines successively select four X-drive lines constituting a closed loop (in the case of double closed loop) and connect the closed-loop circuit and the X-drive lines. In synchronism therewith, lead-out switches SW1 and SW2 of the second closed-loop forming circuit are successively turned on to introduce a current of the closed-loop circuit to external terminals T1 and T2. To the external terminal T1 and T2, an AC power source and a circuit 41 for detecting an induction current are electrically connected in series. The open/close timing of the switching circuits 22 and 23 and the detection timing of the induction current detection circuit are controlled by a control circuit (not shown). The closed loops are similarly formed with respect to Y-drive lines and are successively switched. In the case where only one of the X coordinate and the Y coordinate is detected, it is sufficient to form only one type of the closed loops with the X-drive lines and the closed loops with the Y-drive lines. Switches SW3 and SW4 have the same function as the switches SW1 and SW2. Further, terminals T2 and T4 are electrically connected with a detection circuit 42 having the same function as the circuit 41.

On the display panel, when a position indicator 40 for indicating a coordinate position such as a pen for input is placed to change an induction current, the coordinate position can be detected. This detection principle is the same as those described in JP-A No. Hei 10-49301 and U.S. Pat. No. 5,693,913. For example, in the former case, an induction coil is incorporated in an input pen to emit electromagnetic wave, whereby a high-frequency induction current passes through a closed loop. From timing of a peak of the induction current, a position of the input pen is determined.

As described above, at one terminal portion of the X-drive lines, the switching circuit 25 and the X drive line drive circuit 24 for display drive similarly as in the conventional apparatus are disposed. At one terminal portion of the Y-drive lines, the switching circuit 35 and the Y drive line drive circuit 35 for display drive similarly as in the conventional apparatus and disposed. Incidentally, in the case where the X drive line drive circuit 24 has a function of disconnecting the X-drive lines therefrom, it is not necessary to use the switching circuit 25. Similarly, in the case where the Y drive line drive circuit 35 has a function of disconnecting the Y-drive lines therefrom, it is not necessary to use the switching circuit 35.

The coordinate input apparatus of the present invention includes the display panel but a display operation and a coordinate detection operation are performed in a time-division manner. More specifically, the switching circuits 22 and 23 and the switching circuits 32 and 33 are placed in an OFF state at the time when drive signals are inputted from the display drive circuits 24 and 34, respectively, and on the other hand, are placed in an ON state at the time of sensing of the coordinate input to form a plurality of multiple closed loops in the arrangement direction of the X-drive lines and in the arrangement direction of the Y-closed loops, respectively, and output an induction current. In this case, the X drive line drive circuit 24 and the X-drive lines are placed in a disconnection state by the switching circuit 25, and the Y drive line drive circuit 34 and the Y-drive lines are placed in a disconnection state by the switching circuit 35, thus permitting output of the induction current.

Compared with the conventional signal closed-loop circuit, in the case of the double closed-loop circuit, an induction current at the same electromagnetic wave intensity is increased to two time (that of the case of the conventional single closed-loop circuit), so that an S/N ratio of sensing can be improved. Further, even when the electromagnetic wave intensity is small, it is possible to generate an induction current which permits sensing, so that it is possible to reduce power consumption for generating the induction current in the position indicator.

### EMBODIMENT 2

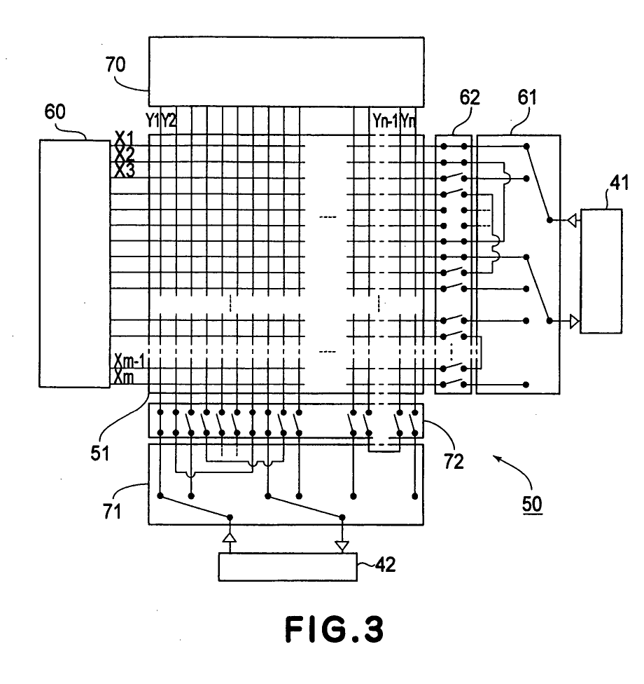

In FIG. 3, a coordinate input apparatus 50 is an electromagnetic induction-type coordinate input apparatus including an active matrix-type liquid crystal (display) panel 51 similarly as in Embodiment 1. The liquid crystal panel 51 has, similarly as in the conventional one, a plurality of X-drive lines X1 to Xn and a plurality of Y-drive lines Y1 to Yn which are disposed to intersect with each other.

The coordinate input apparatus 50 in this embodiment includes an X-drive/closed-loop forming circuit 60 which has a function of an X drive circuit for display drive and a function of a closed-loop forming circuit for forming a double closed loop with four X-drive lines in combination at one terminal portion of the X-drive lines and includes a Y-drive/closed-loop forming circuit 70 which has a function of an X drive circuit for display drive and a function of a closed-loop forming circuit for forming a double closed loop with four Y-drive lines in combination at one terminal portion of the Y-drive lines.

Further, at the other terminal portion of the X-drive lines, the coordinate input apparatus 50 includes a multiplexer-like circuit 61 capable of forming a double closed loop with four X-drive lines and outputting an induction current, by electromagnetic wave from the position indicator, successively from a plurality of double closed loops formed in the arrangement direction of the X-drive lines, and at the other terminal portion of the y-drive lines, the coordinate input apparatus 50 includes a multiplexer-like circuit 71 capable of forming a double closed loop with four Y-drive lines and outputting an induction current, by electromagnetic wave from the position indicator, successively from a plurality of double closed loops formed in the arrangement direction of the Y-drive lines. These circuits 61 and 71 are formed on the active matrix substrate constituting the liquid crystal panel 51.

The liquid crystal panel 51 includes a circuit 61 for forming a closed loop and outputting an induction current, a switching circuit for electrically connecting the X-drive lines, a circuit 71 for forming a closed loop and outputting an induction current, and a switching circuit for electrically connecting the Y-drive lines.

The switching circuits 62 and 72 are in synchronism with the X-drive/closed-loop forming circuit 60 and the Y-drive closed-loop forming circuit 70, respectively, and are placed in an OFF state at the time of the display drive of the liquid crystal panel 51 and placed in an ON state at the time of sensing of the coordinate input to form a plurality of multiple closed loops in the arrangement direction of the X-drive lines and in the arrangement direction of the Y-closed loops, respectively, and output an induction current. At the time of sensing, the X drive circuit portion and the X-drive lines are placed in a disconnection state by a switch (not shown) circuit 60, and the Y drive circuit portion and the Y-drive lines are placed in a disconnection state by a switch (not shown) the circuit 70, thus permitting output of the induction current.

According to this embodiment, compared with the conventional signal closed-loop circuit, in the case of the double closed-loop circuit, an induction current at the same electromagnetic wave intensity is increased, so that an S/N ratio of sensing can be improved. Further, even when the electromagnetic wave intensity is small, it is possible to generate an induction current which permits sensing, so that it is possible to reduce power consumption for generating the induction current.

The coordinate input apparatus of the present invention is also applicable to an electrophoretic display panel (having a memory characteristic) using an active matrix substrate.

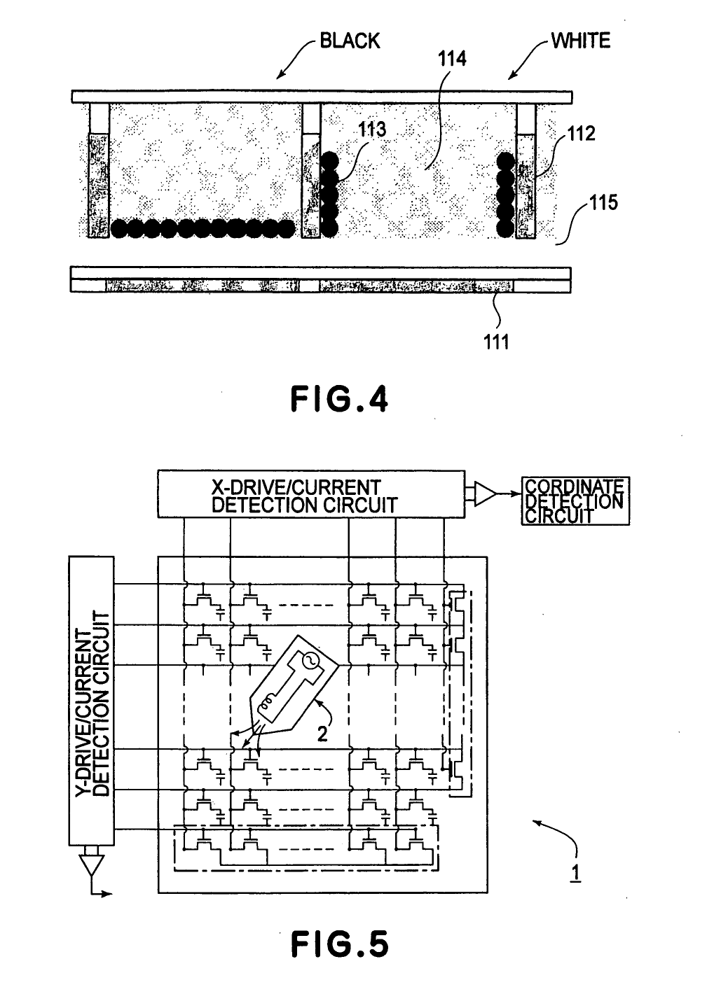

An electrophoretic display panel 51 having a memory characteristic used in the present invention will be described with reference to FIG. 4 showing a schematic pixel cross-section of an electrophoretic display apparatus.

Referring to FIG. 4, a display portion having pixels includes a drive electrode 111 connected to a drain of a thin film transistor (TFT) device, a common electrode 112 driven for all the pixels in common, particularly charged black electrophoretic particles 113, a dispersion liquid 114 comprising a liquid and the plurality of electrophoretic particles 113, and an insulating reflection layer 115. The common electrode 112 is grounded. When a positive-polarity voltage (+V1) is applied to the drive electrode 111, the positively charged black electrophoretic particles 113 are collected in the neighborhood of the common electrode 112 to expose the reflection layer 115 at the bottom surface of the display portion (white state). On the other hand, when a negative-polarity voltage (−V1) is applied to the drive electrode, the positively charged black electrophoretic particles 113 are collected on and in the neighborhood of the drive electrode 111 to cover the reflection layer 115 at the bottom surface (black state). The pixel once placed in the white state or the black state is kept in the previous state as it is even when 0 V is applied between the electrodes 111 and 112. Such an electrophoretic display panel is described specifically in, e.g., U.S. Pat. No. 6,239,896.

Other constitutions of the electrophoretic display panel 51 are the same as those of the liquid crystal panel 51 used in Embodiment 2 described above, thus being omitted from explanation.

In the above described embodiments, the case of the active matrix drive-type coordinate input and display apparatus including TPO pixel circuits each provided with the switching device, such as the TFT device, and including data lines and scanning lines (X-drive lines and Y-drive lines) which are disposed to intersect with each other to provide a plurality of intersections each provided with an associated pixel circuit is described. However, the present invention is also applicable to a simple matrix drive-type coordinate input and display apparatus. In the simple matrix drive method, a plurality of line-like first electrodes (corresponding to the X-drive lines) and a plurality of line-like second electrodes (corresponding to the Y-drive lines) are disposed to intersect with each other in a matrix fashion. At each of the intersections, a pixel is disposed and an electrical action is selectively exerted on the pixel to drive and control the pixel.

### INDUSTRIAL APPLICABILITY

According to the coordinate input apparatus of the present invention, the closed-loop circuit using the X-drive lines or the Y-drive lines is constituted by a multiple closed loop having two or more loops, so that it is possible to enhance a receiving sensitivity of a signal from the position indicator compared with the case of the single closed loop. As a result, it is possible to improve the S/N ratio at the time of sensing and reduce the power consumption.

While the invention has been described with reference to the structures disclosed herein, it is not confined to the details set forth and this application is intended to cover such modifications or changes as may come within the purpose of the improvements or the scope of the following claims.

1. A coordinate input apparatus, comprising:
a plurality of X interconnecting lines and a plurality of Y interconnecting lines disposed to intersect with each other in a matrix fashion;
a closed-loop forming circuit for being electrically connected with the X interconnecting lines or the Y interconnecting lines so as to switchably connect a predetermined number of the X interconnecting lines or a predetermined number of the Y interconnecting lines to form a closed loop; and
a detection circuit for detecting a signal outputted from the closed loop in response to a position indicator for indicating a position in a coordinate input area where the X interconnecting lines and the Y interconnecting lines are disposed in the matrix fashion;
wherein the closed loop is a multiple closed loop.

2. An apparatus according to claim 1, wherein the closed loop includes a switch circuit for selecting first to four X interconnecting lines from the plurality of X interconnecting lines so that:
a first terminal of the first X interconnecting line is connected with a first terminal of the second X interconnecting line,
a first terminal of the third X interconnecting line is connected with a first output terminal,
a second terminal of the third X interconnecting line is connected with a second terminal of the first X interconnecting line,
a first terminal of the fourth X interconnecting line is connected with a second output terminal, and
a second terminal of the fourth X interconnecting line is connected with a second terminal of the second X interconnecting line.

3. An apparatus according to claim 2, wherein the closed loop includes a switch circuit for selecting first to four Y interconnecting lines from the plurality of Y interconnecting lines so that:
a first terminal of the first Y interconnecting line is connected with a first terminal of the second Y interconnecting line,
a first terminal of the third Y interconnecting line is connected with a first output terminal,
a second terminal of the third Y interconnecting line is connected with a second terminal of the first Y interconnecting line,
a first terminal of the fourth Y interconnecting line is connected with a second output terminal, and
a second terminal of the fourth Y interconnecting line is connected with a second terminal of the second Y interconnecting line.

4. An apparatus according to claim 1, wherein the closed loop is sequentially formed at a constant pitch on the matrix of the X and Y interconnecting lines with a lapse of time.

5. An apparatus according to claim 1, wherein on the matrix of the X and Y interconnecting lines, a closed loop formed timewise previously and a subsequent closed loop formed after the closed loop are selected to have an embedded structure.

6. An apparatus according to claim 1, wherein the coordinate input area is formed in a display panel.

7. An apparatus according to claim 6, wherein the apparatus further comprises a circuit for switching a display drive mode using the matrix of the X and Y interconnecting lines and a coordinate detection drive mode using the matrix of the X and Y interconnecting lines.

8. An apparatus according to claim 6, wherein the display panel has a memory characteristic.

9. An apparatus according to claim 8, wherein the display panel is an electrophoretic display panel.
